(19) United States
(12) Patent Application Publication
(10) Pub. No.: US 2021/0014292 A1
(43) Pub. Date: Jan. 14, 2021

(54) SYSTEMS AND METHODS FOR VIRTUAL REALITY ENGAGEMENT

(71) Applicant: IQ2 HOLDINGS, INC., Montreal (CN)

(72) Inventor: Mathieu Chambon-Cartier, Montreal (CA)

(73) Assignee: IQ2 HOLDINGS, INC., Montreal, QC (CA)

(21) Appl. No.: 16/885,425

(22) Filed: May 28, 2020

Related U.S. Application Data
(60) Provisional application No. 62/873,531, filed on Jul. 12, 2019.

(51) Int. Cl. H04L 29/06; H04N 21/431; G06F 3/01

(52) U.S. Cl. CPC H04L 65/601; G06F 3/011; H04N 21/431

(57) ABSTRACT

Disclosed herein are embodiments of systems, methods, and products comprises an analytic server for VR engagement with electronic video files. The analytic server receives a plurality of electronic video files recorded by a plurality of electronic file generators for different scenarios/storylines. These different scenarios provide different choices for the story development of a movie at a particular time point. The analytic server categorizes the electronic video files and creates different scenarios at different time points by associating the image sequence, soundtrack, and subtitle of each electronic video file with a scenario and a time point. The analytic server plays a first electronic video file in a default scenario. In the meantime, the analytic server provides an interactive graphical component for the user to choose a different scenario. Upon the user selecting a different scenario, the analytic server plays a second electronic video file in the selected scenario.

### RELATED APPLICATION DATA

This application claims the benefit of priority U.S. Provisional Application No. 62/873,531, filed Jul. 12, 2019, and all the benefits accruing therefrom under 35 U.S.C. § 119, the contests of which are incorporated herein by reference in their entirety.

### TECHNICAL FIELD

This application relates generally to methods and systems for virtual reality engagement with electronic video files.

### BACKGROUND

Video streaming has been one of the most popular and important forms of entertainment. People spend many hours watching television shows, movies, live streams, video clips, documentary films, and the like. However, conventional methods of streaming videos do not allow users to customize the streaming video being displayed. For instance, a video producer may record, edit, and generate multiple versions of a video (e.g., a movie). However, only a single version may be selected as the final version. Conventional streaming methods do not provide users the option to view other video versions or video streams available. In addition, conventional streaming methods are unilateral and do not allow users to interact with the video being streamed. For instance, users are unable to customize the video feed or change the course of the plot development or the story structure in the movie. Users who use conventional streaming methods do not have the option to customize any portion of the video being streamed, which is undesirable and may create a negative user experience.

### SUMMARY

For the aforementioned reasons, there is a need for a system and method for generating electronic video files for different scenarios/storylines to provide different choices for the story structure in a video. There is a need for displaying the video files in one or more scenarios based on a user's selection. There is a further need for an interactive system and method for allowing a user to interact with the video player device and select one or more scenarios to watch the video.

Embodiments disclosed herein address the above challenges by providing an interactive way of engaging virtual reality (VR) or augmented reality (AR). Specifically, an analytic server may receive a plurality of electronic video files recorded by a plurality of electronic file generators for different scenarios. Such electronic video files may include image sequences, soundtracks and subtitles and may be in different languages. Each scenario may be a different storyline of a movie comprising a sequence of events specific to that storyline. At a particular time point, the movie may provide the different scenarios for the story development. The movie may have multiple such time points. The analytic server may create different scenarios at different time points for the movie by associating the image sequence, the soundtrack, and the subtitle of each electronic video file with a scenario and a time point. When the analytic server plays the movie on a video player device and reaches one of such time points, the analytic server may play a first electronic video file in a default scenario. In the meantime, the analytic server may provide an interactive graphical component for the user to choose a different scenario. Upon the user selecting a different scenario, the analytic server may play a second electronic video file in the selected scenario.

In one embodiment, a method comprises receiving, by a server, a plurality of electronic video files, each electronic video file corresponding to a different event sequence; while displaying a first electronic video file on an electronic device, displaying, by the server, on a predetermined display portion of a display of the electronic device, an interactive graphical component comprising options for displaying a plurality of event sequences of the plurality of electronic video files; activating, by the server, a sensor to monitor a user's actions while viewing the first electronic video file; and in response to the user's action corresponding to a selection of a new event sequence, transitioning, by the server, from the first electronic video file to a second electronic video file corresponding to the new event sequence by displaying the second electronic video file instead of the first electronic video file.

In another embodiment, a computer system comprises a plurality of electronic file generators, an electronic device, a server in communication with the plurality of electronic file generators and the electronic device and configured to: receive a plurality of electronic video files from the plurality of electronic file generators, each electronic video file corresponding to a different event sequence; while displaying a first electronic video file on the electronic device, display, on a predetermined display portion of a display of the electronic device, an interactive graphical component comprising options for displaying a plurality of event sequences of the plurality of electronic video files; activate a sensor to monitor a user's actions while viewing the first electronic video file; and in response to the user's action corresponding to a selection of a new event sequence, transition from the first electronic video file to a second electronic video file corresponding to the new event sequence by displaying the second electronic video file instead of the first electronic video file.

In an embodiment, there is disclosed a method comprising: (a) receiving, by a server, a plurality of electronic video files, each electronic video file corresponding to a different event sequence; (b) while displaying a first electronic video file on an electronic device, displaying, by the server, on a predetermined display portion of a display of the electronic device, an interactive graphical component comprising options for displaying a plurality of event sequences of the plurality of electronic video files; (c) activating, by the server, a sensor to monitor a user's actions while viewing the first electronic video file; and (d) in response to the user's action corresponding to a selection of a new event sequence, transitioning, by the server, from the first electronic video file to a second electronic video file corresponding to the new event sequence by displaying the second electronic video file instead of the first electronic video file.

In an embodiment, the first electronic video file corresponds to a default event sequence.

In an embodiment, the method further comprises: (a) embedding, by the server, a tag into a video indicating the plurality of event sequences available at a time point; (b) detecting, by the server, the tag embedded in the video while playing the video; and (c) displaying, by the server, the interactive graphical component.

In an embodiment, the method further comprises: (a) detecting, by the server, a tag embedded in a video indicating the plurality of event sequences available at a time point; and (b) pausing, by the server, the video and displaying the interactive graphical component.

In an embodiment, the method further comprises displaying, by the server, the interactive graphical component for a limited amount of time.

In an embodiment the method further comprises displaying, by the server, the second electronic video file from beginning of the second electronic video file.

In an embodiment, the method further comprises, at a time point of displaying the second electronic video file, displaying, by the server, the interactive graphical component comprising options for displaying a second plurality of event sequences.

In an embodiment, the first and second electronic video files are in multiple languages.

In an embodiment, each electronic video file comprises an image sequence, a soundtrack, and a subtitle.

In an embodiment the method further comprises receiving, by the server, the user's selection of the new event sequence through body movement, remote control, touch screen, voice control, emotion control and haptic control.

In an embodiment, there is provided a computer system comprising a plurality of electronic file generators; an electronic device; and a server in communication with the plurality of electronic file generators and the electronic device, the server being configured to: (a) receive a plurality of electronic video files from the plurality of electronic file generators, each electronic video file corresponding to a different event sequence; (b) while displaying a first electronic video file on the electronic device, display, on a predetermined display portion of a display of the electronic device, an interactive graphical component comprising options for displaying a plurality of event sequences of the plurality of electronic video files; (c) activate a sensor to monitor a user's actions while viewing the first electronic video file; and (d) in response to the user's action corresponding to a selection of a new event sequence, transition from the first electronic video file to a second electronic video file corresponding to the new event sequence by displaying the second electronic video file instead of the first electronic video file.

In an embodiment, the first electronic video file corresponds to a default event sequence.

In an embodiment, the server is further configured to: (a) embed a tag into a video indicating the plurality of event sequences available at a time point; (b) detect the tag embedded in the video while playing the video; and (c) display the interactive graphical component.

In an embodiment, the server is further configured to: (a) detect a tag embedded in a video indicating the plurality of event sequences available at a time point; and (b) pause the video and display the interactive graphical component.

In an embodiment, the server is further configured to display the interactive graphical component for a limited amount of time.

In an embodiment, the server is further configured to display the second electronic video file from beginning of the second electronic video file.

In an embodiment, the server is further configured to, at a time point of displaying the second electronic video file, display the interactive graphical component comprising options for displaying a second plurality of event sequences.

In an embodiment, the first and second electronic video files are in multiple languages.

In an embodiment, each electronic video file comprises an image sequence, a soundtrack, and a subtitle.

In an embodiment, the server is further configured to receive the user's selection of the new event sequence through body movement, remote control, touch screen, voice control, emotion control and haptic control.

It is to be understood that both the foregoing general description and the following detailed description are exemplary and explanatory and are intended to provide further explanation of the disclosed embodiment and subject matter as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a computer system for virtual reality engagement with electronic video files, according to an embodiment.

FIG. 2 illustrates a flowchart depicting operational steps for virtual reality engagement with electronic video files, according to an embodiment.

FIG. 3 illustrates an example of generating and displaying electronic video files for different scenarios, according to an embodiment.

FIG. 4 illustrates an example of a video with multiple scenarios at different time points, according to an embodiment.

FIG. 5 illustrates an example of the graphical user interfaces when a user changes scenarios, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Embodiments disclosed herein provide a system and method for engaging with virtual reality (VR) by allowing users to choose different scenarios/storylines for the course of plot development in a movie. An analytic server may provide a video stream software application (e.g., web application and/or mobile application) with various VR engagement functions. Upon a user installs and initiates the software application, the analytic server may provide a list of movies for the user to view. A movie may include multiple scenarios/storylines at different time points. Specifically, a plurality of electronic file generators may record videos for different scenarios and generate a plurality of electronic video files. As the software application playing the movie, the analytic server may detect a tag indicating there are multiple scenarios available at a time point. The analytic server may initially display the video file in a default scenario. In the meantime, the analytic server may display an interactive graphical component that allows the user to select a different scenario. Based on the user's selection, the analytic server may display a new video file corresponding to the selected scenario. As a result, the user may be able to watch the movie in different scenarios and change the story structures of the movie.

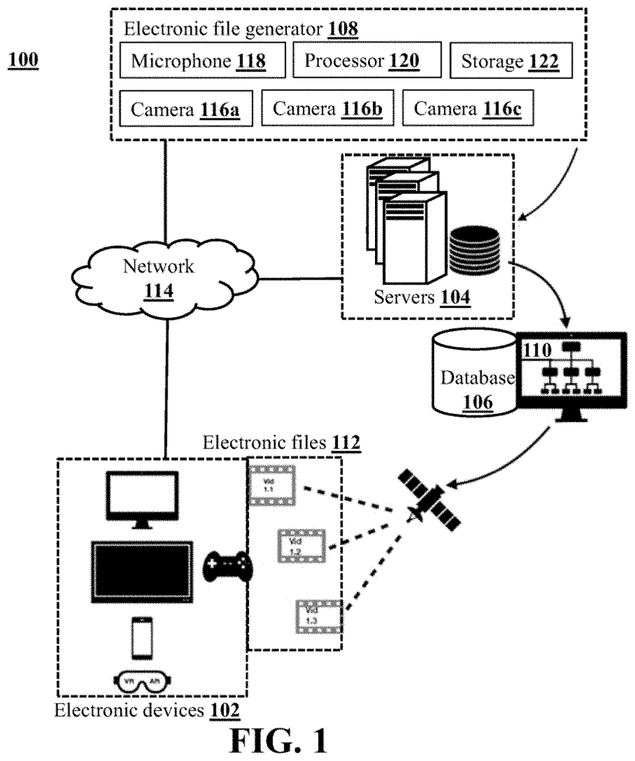

FIG. 1 illustrates components of a system 100 for virtual reality engagement with electronic video files, according to an embodiment. The system 100 may comprise electronic devices 102, one or more analytic servers 104, a database 106, and electronic file generator 108, that are connected with each other via hardware and software components of one or more networks 114. The electronic file generator 108 may refer to one or more electronic devices configured to generate electronic files capturing audio and/or video associated with different scenarios/storylines. The electronic file generator 108 may include a microphone 118, processor 120, storage 122, and/or cameras 116a-116c. As described below, multiple cameras may generate multiple electronic files associated with the multiple scenarios. In some embodiments, multiple cameras may record the same event from different angles (viewpoints). The electronic file generator 108 may either directly communicate with the servers 104 or communicate with the servers 104 utilizing the network 114 to transmit the generated electronic files.

The network 114 may include, but is not limited to, a private local area network or a public local area network, a wireless local area network, a metropolitan area network, a wide-area network, and Internet. The network 114 may further include both wired and wireless communications, according to one or more standards, via one or more transport mediums. The communication over the network 114 may be performed in accordance with various communication protocols, such as, a transmission control protocol and an internet protocol, a user datagram protocol, and an institute of electrical and electronics engineers communication protocols. The network 114 may further include wireless communications, according to Bluetooth specification sets, or another standard or proprietary wireless communication protocol. The network 114 may further include communications over a cellular network, including, for example, a global system for mobile communications, code division multiple access, and enhanced data for global evolution network.

The system 100 is described in a context of computer-executable instructions, such as program modules, being executed by server computers, such as an analytic server 104. The analytic server 104 may build an application that can be installed and executing on the electronic devices 102. For example, the analytic server 104 may provide a video stream application installed on a mobile device or a smart TV. The program modules of the application may include programs, objects, components, data structures, etc., which may perform different tasks described herein. The features of the system 100 may be practiced either in a computing device, or in a distributed computing environment, where the tasks described herein are performed by processing devices, which are linked through a network 114. In a distributed computing environment, program modules may be located in both local and remote computer storage media including memory storage devices.

The analytic server 104 may receive a plurality of electronic video files from the electronic file generators 108. Each electronic file generator 108 may record the video for a scenario comprising a sequence of events happened in the storyline of that particular scenario. The electronic video files generated by the different electronic file generators 108 may provide different choices at a time point for the story development of the video. A video may have multiple scenario options at different time points. In some embodiment, each electronic file generator 108 may record the video from a particular angle. As a result, the electronic video files generated by the different electronic file generators 108 may be the same scene recorded from different angles. The analytic server 104 may save the electronic video files into a database 106 with the metadata indicating each electronic video file's scenario or angle, and the time point. The analytic server 104 may initially display the electronic video file of a defaulting setting (e.g., a default scenario/angle) on the electronic devices 102. A user operating the electronic device 102 may interact with the graphical user interface (GUI) of the video stream application and select another scenario/angle. Based on the user's selection, the analytic server 104 may retrieve the electronic video file of the selected scenario/angle from the database 106. The analytic server 104 may transmit the electronic video file of the selected scenario/angle to the electronic device 102 over the network 114. The electronic device 102 may play the received electronic video file that is corresponding to the scenario/angle required by the user.

The electronic file generator 108 may be a portable or a non-portable electronic device, which is configured to perform operations according to programming instructions. The electronic file generators 108 may execute algorithms or computer executable program instructions, which may be executed by a single processor or multiple processors in a distributed configuration. The electronic file generators 108 may be configured to interact with one or more software modules of a same or a different type operating within the system 100.

The electronic file generators 108 may include a processor or a microprocessor for performing computations for carrying the functions of the electronic file generators 108. Non-limiting examples of the processor may include, but are not limited to, a microprocessor, an application specific integrated circuit, and a field programmable object array, among others. The processor may include a graphics processing unit specialized for rendering and generating computer-generated graphics. Non-limiting examples of the electronic file generators 108 may include, but are not limited to, a camera device, a video camera device, or a mobile device.

The electronic file generators 108 may include an operating system for managing various resources of the electronic file generators 108. An application programming interface associated with the operating system may allow various application programs to access various services offered by the operating system. For example, the application-programming interface may be configured for setting up wired or wireless connections to the analytic server 104. As a result, the electronic file generators 108 are capable of communicating with the analytic server 104 through the network 114 using wired or wireless communication capabilities.

The electronic file generators 108 may include the processor, which may execute one or more three-dimensional (3D) filming techniques and/or four-dimensional (4D) filming techniques to generate electronic files, such as video files. The filming techniques may include development software, pre-production software, production software, and post-production software. Using the 3D filming techniques and/or the 4D filming techniques, one or more cameras of the electronic file generators 108 may generate the electronic video files. The cameras may capture still images or record moving images and soundtracks from an environment that is within a field of view of the electronic file generators 108. The electronic file generators 108 may process the captured images and soundtracks in real-time and generate electronic video files based on the captured images and soundtracks.

The multiple electronic file generators 108 may capture the images and soundtracks of different scenarios and generate an image sequence file for the video content, a soundtrack file for the audio content for each scenario. The electronic file generator 108 may also generate the soundtrack file for the audio content in different languages, and generate subtitle files for the audio content in different languages.

In the embodiments of recording a scene from different angles, the multiple electronic file generators 108 may capture the images and soundtracks of a scene from different angles simultaneously. For example, the multiple electronic file generators 108 may synchronize with each other and start recording videos at the same time. The analytic server 104 may instruct the multiple electronic file generators 108 to start recording at the same time. Each electronic file generator 108 may capture the images and soundtracks from a particular angle. In some embodiments, the analytic server 104 may transmit instructions to the electronic file generators 108 for setting up the angle of each electronic file generator 108.

After the electronic file generators 108 generate the electronic video files, the electronic file generators 108 may transmit the electronic video files to the analytic server 104 via the network 114. The analytic server 104 may store the electronic video files, and the identifiers (IDs) of the corresponding electronic file generators transmitting the electronic video files, and the scenario/angle and time point of each electronic video file in the database 106.

The analytic server 104 may categorize the electronic video files and create different scenarios. The analytic server may 104 categorize the electronic video files by tagging each electronic video file with the scenario data, including the time point, the setting of the scenario. The analytic server 104 may create a reference table 110 in the database to record the category of each electronic video file in a data field of the reference table. The reference table 110 may include the time point, the setting of scenario, the storage address of the corresponding electronic video file, and the ID of the electronic video file, including the image sequence file, the soundtrack file, the subtitle file. For example, the reference table 110 may indicate that at time point T, there are two available scenarios S1, S2. For the first scenario S1, the corresponding electronic video file Vid1.1 includes the image sequence file Vid1.1-video for video content, the soundtrack file Vid1.1-audio for audio content, and subtitle file Vid1.1-subtitle for the subtitle. Furthermore, for each time point with multiple scenario options, the analytic server 104 may select one of the scenarios as a default scenario, and mark the selected scenario as default in the reference table 110.

In the embodiments of receiving the electronic video files recorded from different angles, the analytic server 104 may categorize the electronic video files and create video scenarios corresponding to different angles by attaching the angle of each electronic video file to the metadata of the video file. For example, the analytic server may create a reference table 110 in the database 106 and record the angle of each electronic video file in a data field of the reference table 110. The reference table 110 may include the event data, electronic video file ID, the electronic file generator ID, the angle of the electronic video file, and the storage addresses of the image sequence and the soundtrack corresponding to the angle. For instance, the reference table 110 may indicate that for movie clip of event A, there are three angles, angles X, Y, Z, corresponding to three electronic video files 112 Vid1.1, Vid1.2, Vid1.3, generated by three electronic file generators. For angle X, the electronic video file includes image sequence and soundtrack captured from that angle. The analytic server 104 may set one of the angles as a default angle.

The electronic device 102 may be a portable or a non-portable computing device that performs operations according to programming instructions. The electronic devices 102 may execute algorithms or computer executable program instructions, which may be executed by a single processor or multiple processors in a distributed configuration. The electronic devices 102 may be configured to interact with one or more software modules of a same or a different type operating within the system 100.

The electronic devices 102 may include a processor or a microprocessor for performing the functions of the electronic devices 102. Non-limiting examples of the processor may include, but are not limited to, a microprocessor, an application specific integrated circuit, and a field programmable object array, among others. The processor may include a graphics processing unit specialized for rendering and generating computer-generated graphics. Non-limiting examples of the electronic devices 102 may include, but are not limited to, a cellular phone, a tablet computer, a head-mounted display, smart glasses, wearable computer glasses, a personal data assistant, a virtual reality device, an augmented reality device, or a personal computer. In augmented reality, the electronic devices 102 may be used to project or superimpose computer-generated images of the electronic video files 112.

The electronic devices 102 may include an operating system for managing various resources of the electronic devices 102. An application-programming interface associated with the operating system may allow various application programs to access various services offered by the operating system. For example, the application-programming interface may be configured for setting up wired or wireless connections to the analytic server 104. As a result, the electronic devices 102 are capable of communicating with the analytic server 104 through the network 114 using wired or wireless communication capabilities. The application-programming interface may access the video streaming service of the operating system to play the electronic video files 112 on the electronic devices 102.

The electronic devices 102 may receive the electronic video files 112 from the analytic server 104 and display the received electronic video files 112 via the video stream application. The electronic devices 102 may comprise a display screen that is implemented as a light emitting display for presentation of the videos of the received electronic video files 112. The display screen may include a head-mounted display system configured for optically presenting information of the electronic video files 112 into the eyes of the user through a virtual retinal display.

The electronic devices 102 may include input and output devices, such as sensors, touch screen, keypad, microphone, mouse, touch screen display, and the like. The input and output devices may allow user interaction with various programs and computer software applications, such as the video stream application. For example, the user may interact with a graphical user interface of the video stream application using the input and output devices to select one or more scenarios/angles of the electronic video files 112 being presented on the display screen of the electronic devices 102. The electronic devices may include sensors, such as an eye-tracking sensor, a head-tracking sensor, or an expression-processing sensor, that monitor the user's actions. The electronic devices 102 may include input and output devices to receive the user's input through body movement, remote control, touch screen, voice control, emotion control (e.g, based on heartbeat), haptic control, and the like. The analytic server 104 may receive the user's input (e.g., request) from the electronic devices 102, retrieve the electronic video files corresponding to the user's input, and transmit the electronic video files to the electronic devices 102 to satisfy the user's request.

The electronic devices 102 may include a web browser. The web browser may access and present the video stream application. Alternatively, the electronic devices 102 may include a mobile application installed locally. The video stream application (e.g., web application or mobile application) may be implemented in the processor of the electronic devices 102. The implementation of the video stream software application may be a computer program product, stored in non-transitory storage medium, when executed on the processor. The video stream software application may be a software stack running on the operating system of the electronic devices 102. The video stream software application may run in different electronic devices with different operating systems. For example, the software application may run on Android® devices, Oculus® devices, OpenVR® devices, iOS® devices, SteamVR® devices, HTC® devices, WMR (Windows® Mixed Reality) devices, and PlayStation® VR (PSVR) devices.

The video stream software application may communicate with the analytic server 104 to satisfy the user's various requests. For example, the video stream application may comprise a graphical user interface configured to receive user requests. The video stream application may communicate with the analytic server 104 to transmit the user requests, receive the requested electronic video files 112 from the analytic server 104 and display the received electronic video files 112 on the user's electronic device 102.

As the electronic video files 112 are being accessed by the user on the electronic device 102, in the background process, the video stream application may monitor the status of the electronic video files being displayed, including a tag indicating there are multiple scenario options, the time point of the tag, the timestamp of the frame being presented. The analytic server 104 may set one of the scenarios as a default scenario. The electronic device 102 may initially display the electronic video file corresponding to the default scenario. In some other embodiments, the analytic server 104 may set one of the angles as a default angle. The electronic device 102 may initially display the electronic video files in the default angle.

In the middle of displaying the default scenario, the analytic server 104 may receive the user's request to display a different scenario. When a user selects a scenario from different options by interacting with the interactive graphical component, the analytic server 104 may receive the users request to play the movie according to the storyline of the selected scenario. The received request may comprise the time point (e.g., timestamp) of the tag and the selected scenario. The analytic server 104 may be able to retrieve a second electronic video file corresponding to the time point and the requested scenario from the database 106. The analytic server may 104 display the second electronic video file instead of the first electronic video file on the electronic device 102. By allowing the user to select different scenarios, the analytic server 104 may allow the user to change the story structure and the course of the plot development in the movie.

In some embodiments, in the middle of the displaying, the user may want to watch the video from a different angle for a specific scene or certain frames. The user may interact with the application GUI to select a different angle. The video stream application may communicate with the analytic server 104 by transmitting a tag corresponding to the event with different angles, the requested angle, and other current video status (e.g., frames and/or timestamps of the frames) to the analytic server 104. The analytic server 104 may retrieve the electronic video files based on the tag and the requested angle for the event from the database 106. Furthermore, instead of playing the requested video from the beginning, the analytic server 104 may determine from which part of the video to play in the requested angle based on the current video status. For example, the analytic server 104 may determine that the user was watching movie clip of event A at timestamp T when the user requested to watch from angle Y. The analytic server may display the electronic video file of movie clip for event A in the requested angle Y from the same timestamp T. Alternatively, the analytic server may identify the frame being displayed in the initial electronic video file when the user switches the angle. Based on the frame in the initial electronic video file, the analytic server may determine a frame in the requested video file corresponding to the frame in the initial video file. The analytic server 104 may start the display of the requested electronic video file from the frame corresponding to the frame in the initial electronic video file. As a result, the user may be able to resume watching the video seamlessly from the breakpoint in the selected angle.

The analytic server 104 may be any computing device comprising a processor and other computing hardware and software components, configured to classify different electronic video files based on the scenarios/angles when the video files are generated and transmit electronic video files based on a selected scenario/angle. The analytic server 104 may be logically and physically organized within the same or different devices or structures, and may be distributed across any number of physical structures and locations (e.g., cabinets, rooms, buildings, cities).

The analytic server 104 may be a computing device comprising a processing unit. The processing unit may include a processor with computer-readable medium, such as a random access memory coupled to the processor. The analytic server 104 may be running algorithms or computer executable program instructions, which may be executed by a single processor or multiple processors in a distributed configuration. The analytic server 104 may be configured to interact with one or more software modules of a same or a different type operating within the system 100.

Non-limiting examples of the processor may include a microprocessor, an application specific integrated circuit, and a field programmable object array, among others. Non-limiting examples of the analytic server 104 may include a server computer, a workstation computer, a tablet device, and a mobile device (e.g., smartphone). For ease of explanation, FIG. 1 shows multiple computing devices functioning as the analytic server 104. However, some embodiments may include a single computing device capable of performing the various tasks described herein.

The analytic server 104 may be connected to the electronic device 102, the electronic file generator 108, and the database 106 via the network 114. The analytic server 104 may receive electronic video files corresponding to different scenarios/angles from the multiple electronic file generators 108. The analytic server 104 may categorize the received electronic video files by attaching the time point, the scenario/angle to the image sequence file, the soundtrack file, and the subtitle file of each electronic video file and store the electronic video files and the metadata into the database 106.

The analytic server 104 may receive a notification from the electronic device 102 when the user of the electronic device 102 accesses the electronic video files 112 on the electronic device 102. In some embodiments, the analytic server 104 may receive the notification from the video stream application being executed on the electronic device 102 when the user of the electronic device 102 accesses the electronic video files 112 on the electronic device 102.

The analytic server 104 may access the electronic video files 112 in a background process upon receiving the notification. In some embodiments, the analytic server 104 may access the electronic video file of the default scenario/angle from the database 106. Upon accessing the electronic video files 112, the analytic server 104 may transmit the electronic video files 112 to the electronic device 102. Upon receiving a user request to play the video in a different scenario/angle, the analytic server 104 may access the electronic video file of the requested scenario/angle from the database 106, and transmit the image sequence file, the soundtrack file, and the subtitle file of the requested electronic video file to the electronic device 102 for presentation.

The database 106 may be any non-transitory machine-readable media configured to store data, including electronic video files generated for different scenarios or from different angles at different time points, the image sequence, soundtrack, and subtitle of each electronic video file, the metadata of each electronic video file, such as the scenario/angle, the identifier, the time point, the timestamp of each frame of the video, and the like. The database 106 may include any other related data of the electronic video files. The database 106 may be part of the analytic server 104. The database 106 may be a separate component in communication with the analytic server 104. The database 106 may have a logical construct of data files, which may be stored in non-transitory machine-readable storage media, such as a hard disk or memory, controlled by software modules of a database program (e.g., SQL), and a database management system that executes the code modules (e.g., SQL scripts) for various data queries and management functions.

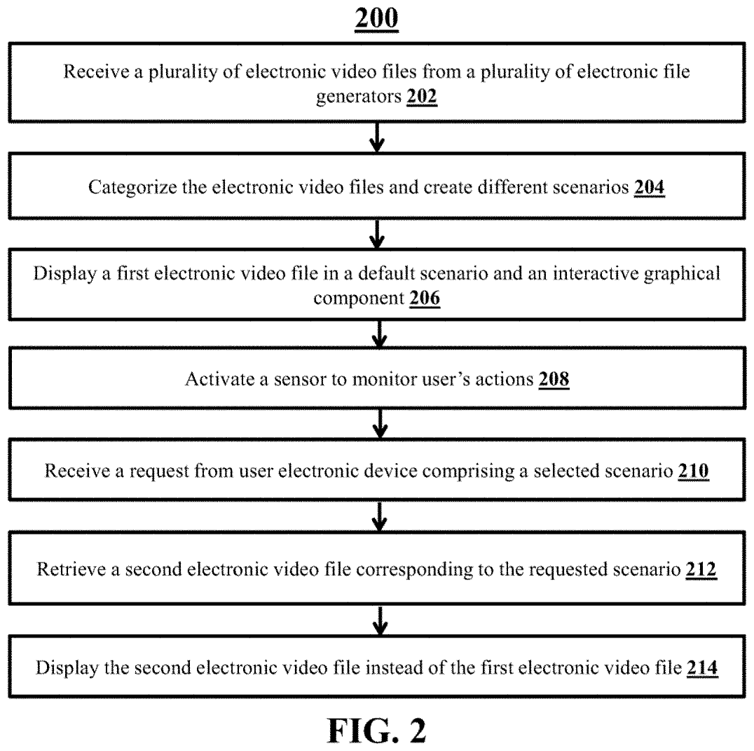

FIG. 2 illustrates execution of a method 200 for virtual reality engagement with electronic video files, according to an embodiment. Other embodiments may comprise additional or alternative steps, or may omit some steps altogether.

At step 202, the analytic server may receive a plurality of electronic video files from a plurality of electronic file generators, each electronic video file corresponding to a different event sequence. The plurality of electronic file generators may record different scenarios or storylines of a video (e.g., a movie). Each generated electronic video file may correspond to a specific scenario or storyline and comprise a sequence of events for that scenario. These different scenarios or storylines may provide different choices for the story development of the movie at a particular time point. Each movie may have multiple such time points where there are different scenarios with each scenario corresponding to a different plot development of the storyline.

For example, as the movie starts, the character in the movie may be in the living room of a house. At a particular time point, such as 4:50, the movie may provide two scenarios. In a first scenario, the character may go to the kitchen. In a second scenario, the character may go to the bedroom. For each scenario, the electronic file generator may generate an electronic video file that includes the sequence of events happen in that scenario. The electronic video file for a scenario may comprise an image sequence file for video content, a soundtrack file for audio content where the soundtrack file may have different versions in different languages, and one or more subtitle files (if needed).

In some embodiments, each electronic video file may comprise a video file corresponding to an event recorded from a different angle. Each electronic video file may comprise an image sequence file and a soundtrack file recorded from a particular angle. The event may correspond to a scene in a movie or any other videos. The plurality of electronic file generators may generate the plurality of electronic video files by capturing the images and soundtracks of the scene (e.g., the event) from different angles simultaneously. For example, the multiple electronic file generators may synchronize with each other and start recording videos at the same time. The analytic server may transmit an instruction to the multiple electronic file generators to start their recording at the same time. Each electronic file generator may capture the images and soundtracks from a particular angle. In some embodiments, the analytic server may transmit instructions to the electronic file generators for setting up the angle of each electronic file generator.

After the electronic file generators generate the electronic video files, the electronic file generators may transmit the electronic video files to the analytic server via the network. The analytic server may store the electronic video files and the scenario/angle of each electronic video file in the database.

At step 204 the analytic server may categorize the electronic video files and create different scenarios. The analytic server may categorize the electronic video files by tagging each electronic video file with the scenario data, including the time point, the setting of the scenario. For example, the tag of an electronic video file may indicate that this video file is for the scenario at time point 4:50 and the setting of the scenario is going to bedroom.

In some embodiments, the analytic server may categorize the electronic video files and create video scenarios corresponding to different angles by attaching the angle of each electronic video file to the metadata of the video file. For example, the analytic server may tag each electronic video file with the event data, and the angle of generating the electronic video file. For example, the tag of an electronic video file may indicate that this video file is for event A and from angle X.

The analytic server may create a reference table in the database to record the category of each electronic video file in a data field of the reference table. The reference table may include the time point, the setting of scenario, the storage address of the corresponding electronic video file, and the ID of the electronic video file, including the image sequence file, the soundtrack file, the subtitle file. For example, the reference table may indicate that at time point T, there are two available scenarios S1, S2. For the first scenario S1, the corresponding electronic video file Vid1.1 includes the image sequence file Vid1.1-video for video content, the soundtrack file Vid1.1-audio for audio content, and subtitle file Vid1.1-subtitle for the subtitle. Furthermore, for each time point with multiple scenario options, the analytic server may select one of the scenarios as a default scenario, and mark the selected scenario as default in the reference table.

In some embodiments, the analytic server may create a reference table in the database and record the angle of each electronic video file in a data field of the reference table. The reference table may include the event data, the electronic video file ID, the electronic file generator ID, the angle of the electronic video file, and the storage addresses of the image sequence and the soundtrack corresponding to the angle. For instance, the reference table may indicate that for event A, there are three angles, angles X, Y, Z, corresponding to three electronic video files Vid1.1, Vid1.2, Vid1.3 generated by three electronic file generators. For angle X, the electronic video file includes image sequence P and soundtrack Q captured from that angle. The analytic server may set one of the angles as a default angle.

At step 206, the analytic server may display a first electronic video file in a default setting on the user electronic device and an interactive graphical component on a predetermined display portion of a display of the electronic device. The interactive graphical component may comprise options for displaying a plurality of event sequences (e.g., scenarios) of the plurality of electronic video files. A user operating the electronic device may access a video via the video stream application. For example, the user may watch a movie, in which there are multiple options at different time points for the plot development. Each option corresponds to a scenario or storyline that includes a sequence of events for that scenario/storyline. As the video stream application plays the movie and reaches such a time point, the analytic server may display an interactive graphical component on a predetermined display portion of the display of the electronic device that allows the user to select a scenario from the multiple options. For example, the GUI of the software application may include an interactive component (e.g., a button, a menu, a textbox, and the like) in the top right corner (or any other predetermined portion) of the display screen of electronic device. The interactive component may include the options for different scenarios.

Before the user selects a scenario, the analytic server may initially display a first electronic video file in a default setting. For example, the analytic server may have one of the scenarios marked as default for a particular time point. The analytic server may initially display the electronic video file corresponding to the default scenario (e.g., the default event sequence) at the time point. In some other embodiments, instead of displaying the electronic video file of the default scenario, the analytic server may pause the movie at a certain time point and display the interactive graphical component to wait for the user to select one of the optional scenarios. After receiving the user's selection, the analytic server may resume the playing of the movie by displaying the electronic video file of the selected scenario.

In some embodiment, the user may watch a movie, in which the scene at a certain time point may be the event with video files from different angles. As the video stream application plays the video/movie and reaches the time point, the analytic server may display an interactive graphical component on a predetermined display portion of the display of the electronic device that allows the user to select a different angle. The interactive component may include the options for displaying the same event in different angles. Before the user selects an angle, the analytic server may initially display a first electronic video file in a default angle for the event. For example, assuming there are three angles X, Y, Z for the event, and the default angle is X, the analytic server may display the video file in angle X as the movie presenting the event at the particular moment via the software application.

The analytic server may create a tag for each time point and embed the tags in the movie or video. The tag may indicate a plurality of scenarios (e.g., event sequences) available at a time point. For example, the tag may indicate that there are more electronic video files (including image sequences, soundtracks, and subtitles) for different scenarios at a particular time point. When the playing process reaches the particular time point, the analytic server may detect the tag and display the interactive graphical component. Upon detecting such a tag, the analytic server may either display the electronic video file of the default scenario or pause the video and wait for the user to select a scenario.

The movie may be a long video that includes multiple such time points. For each time point, the analytic server may display the interactive graphical component for a limited amount of time. For example, the analytic server may display the interactive graphical component when the movie reaches the first time point. If the user does not select any scenario from the interactive graphical component, the analytic server may display the video file of the default scenario for this time point. If the user selects a different scenario, the analytic server may display the video file of the selected scenario. After the limited amount of time, the analytic server may stop displaying the interactive graphical component. As the movie continues playing and reaches a second time point with multiple scenario options, the analytic server may display the interactive graphical component again for a limited amount of time to provide the multiple scenario options for the second time point.

At step 208, the analytic server may activate a sensor to monitor the user's actions while viewing the first electronic file. As the analytic server displays the interactive graphical component, the analytic server may activate a sensor of the user's electronic device to monitor and track the user's actions. For example, the analytic server may activate an eye-tracking sensor, a head-tracking sensor, or an expression-processing sensor. The action-tracking sensor may extract information about a movement or an action of the user and determine the user's intention. For example, the eye-tracking sensor may extract information about an eye movement of the user and duration of the user's eye movement within a boundary associated with one or more portions of the displayed application GUI.

The analytic server may utilize sensor or camera data to determine the gaze of a user. In one embodiment, a light (e.g., infrared) is reflected from the user's eye and a video camera or other sensor can receive the corneal reflection. The analytic server may analyze the ocular sensor data to determine eye rotation from a change in the light reflection. A vector between a pupil center and the corneal reflections can be used to compute a gaze direction. Eye movement data may be based upon a saccade and/or a fixation, which may alternate. A fixation is generally maintaining a visual gaze on a single location, and it can be a point between any two saccades. A saccade is generally a simultaneous movement of both eyes between two phases of fixation in the same direction.

At step 210, the analytic server may receive a request from the user electronic device comprising a selected scenario (e.g., a new event sequence). When a user selects a scenario from different options by interacting with the interactive graphical component, the analytic server may receive the user's request to play the movie according to the storyline of the selected scenario. The received request may comprise the time point (e.g., timestamp) of the tag and the selected scenario. For example, at a particular time point, such as 4:50, the movie may provide two scenarios. In a first scenario, the character may go to the kitchen. In a second. scenario, the character may go to the bedroom. The analytic server may display the first scenario (e.g., going to kitchen) as the default scenario. In the middle of displaying the default scenario, the analytic server may receive the user's request to display the second scenario (e.g., going to bedroom).

The analytic server may receive the user's request through different input methods. The analytic server may receive the user's selecting of the new scenario/angle through body movement, remote control, touch screen, voice control, emotion control (e.g., based on heartbeat), haptic control, and the like. For example, the eye-tracking sensor may tracks the user's eye movement. Based on the sensor data, the analytic server may determine the location of the user's gaze. The location of the user's gaze may correspond to the user's selection of the new scenario/angle. In another example, the analytic server may receive the user's input through remote control when the user uses other devices (e.g., remote controller) to control a smart television. The analytic server may receive the user's input when the user runs his/her finger along the touch screen of a smartphone. In some embodiments, the analytic server may receive the user's input through mind control, voice control, emotion control (e.g., based on heartbeat), and/or haptic control.

In some embodiment, the electronic device may initially play the electronic video file in the default angle for the event included in the movie/video. In the middle of the displaying the default video file of the event, the user may want to watch the event from a different angle. The user may interact with the interactive graphical component of the application GUI to select a different angle. The analytic server may receive the user's request to watch the event from the selected angle via the software application. In some embodiments, the analytic server may determine the event being presented based on the tag of the event in the movie via the video stream software application. Based on the tag and the selected angle, the analytic server may be able to retrieve the electronic video file satisfying the user's request. In some embodiments, in addition to the event being presented, the analytic server may further determine the playing status of the event via the software application. For example, the software application may determine the status of the video being presented. The status of the video may comprise the video frames/images being presented when the user selects a different angle and/or timestamps of the frames being presented. After the user requests a different angle by interacting with the interactive graphical component, the software application may transmit the request to the server. The request may comprise the tag, the status of the video, and the selected angle.

At step 212, the analytic server may retrieve a second electronic video tile corresponding to the requested scenario. As discussed above, the analytic server may categorize the electronic video files based on the time points and the scenarios using a reference table in the database. As a result, the analytic server may be able to retrieve the second electronic video file corresponding to the time point and the requested scenario from the database. For example, assuming the user selected the scenario of going to bedroom at time point 4:50, the analytic server may access the database and retrieve the corresponding electronic video file for the scenario of going to bedroom including the image sequence file for video content, the soundtrack file for audio content, and subtitle file for the subtitle. The analytic server may cache the second electronic video file and play the second electronic video file from the beginning. In the process of displaying the second electronic video of the requested scenario, the analytic server may detect another tag indicating there are multiple scenarios at a certain time point of the second electronic video files. The analytic server may display the interactive graphical component comprising options for displaying a new set of scenarios (e.g., event sequences). The user may select one of the scenarios for this time point by interacting with the interactive graphical component.

In the embodiments of selecting an angle for a specific event, the analytic server may retrieve the second electronic video file corresponding to the event and the requested angle. In some embodiments, In some other embodiments, the analytic server may determine the starting point of the second electronic video file. Instead of playing the second video from the beginning, the analytic server may determine from which part of the video to play in the selected angle based on the current video status. For example, the analytic server may determine that the user was watching movie clip of event A at timestamp T when the user requested to watch from angle Y. The analytic server may retrieve the second electronic video file corresponding to event A in angle Y from the database. Instead of displaying the second electronic video file from the beginning, the analytic server may play the second electronic video file from timestamp T. As a result, the user may be able to resume watching the video from the exact breakpoint when the user switches the angle, but from a different angle.

Because the plurality of electronic video files are in synchronization when recorded from different angles, the analytic server may be able to switch to a different angle based on the timestamp. In some alternative embodiments, the analytic server may be able to identify the breakpoint of the video being presented based on the frame/image being presented. For example, the analytic server may identify the frame being displayed in the initial electronic video file (e.g., a first frame in the first electronic video file) when the user switches the angle. The analytic server may determine a frame in the requested video file (e.g., a second frame in the second electronic video file) corresponding to the frame in the initial video file. The analytic server may start the display of the second electronic video file from the second frame corresponding to the first frame. In some embodiments, the user may be able to select the starting point of the second electronic video file by interacting with the video stream application.

At step 214, the analytic server may transition from the first electronic video file to the second electronic video file by displaying the second electronic video file instead of the first electronic video file on the electronic device. For example, assuming the user selects the scenario of going to bedroom, the analytic server may display the electronic video file corresponding to the scenario of going to bedroom. By allowing the user to select different scenarios, the analytic server may allow the user to change the story structure and the course of the plot development in the movie.

In the embodiment of selecting an angle for a specific event, the analytic server may start the display of the second electronic video file from the second frame corresponding to the first frame. The analytic server may transmit the second electronic video file to the user electronic device via the software application. The software application may display the second electronic file instead of the first electronic file on the electronic device. The software application may display the second electronic video file from the beginning. Alternatively, the analytic server may display the second electronic video file from a starting point that corresponds to the breakpoint (e.g., status) of the first electronic video file. As a result, the user may be able to watch a different view of the same event seamlessly in the selected angle. The user may rewind or pause the second electronic video file as watching the video. After the analytic server displays the second electronic video file to an end, the analytic server may go back to the original video (e.g., the movie) and continue playing the original video from the breakpoint when the user switches the angle (e.g., when the user selects the new angle). The analytic server may detect another tag in the process of playing the original video. The analytic server may display the interactive graphical component to allow the user to select an angle for the new event. The analytic server may repeat this process until the end of the original video.

During the immersive experience, the user may have access to a navigation menu that allows the user to play, pause or replay the electronic video file of a particular scenario. Furthermore, the navigation menu may allow the user to exist the video stream application. The user may access the navigation menu by making certain body movements, such as looking at his/her feet. The software application may also allow the user to accelerate or slow the presentation of the image sequences of the video by making certain body movements. For example, when the user moves his/her head down, the analytic server may accelerate the image sequence presenting. When the user moves his/her head up, the analytic server may slow down the image sequence presenting.

The analytic server may integrate various information. In some embodiments, the analytic server may determine and record the user data based on the user's interaction with the video stream application, Such user data may include the number of video files accessed by the user, the timeline or timestamps of selecting options for different scenarios/angles, bandwidth of the user's network channel or quality for the flow of video data, reaction time, previous choices, previously viewed electronic video files, date and time when accessing the electronic video files, geographical location of the user device, and the like. The analytic server may use such user data to recommend videos for the user and/or customize the service for the user based on the user's preferences.

The analytic server may provide various functions. In some embodiments, the video stream application may include a choice of languages at startup and a running tutorial. When a user initiates the software application, the software application may allow the user to select a preferred language for the application. The tutorial may show the user the functions of selecting different scenarios/angles and video players. The software application may also include a list of thumbnails/titles representing all the movies/videos available for viewing. There may be a logo or symbol in the thumbnail/titles indicating that the movies/videos include multiple scenarios/storylines.

By allowing the user to watch a video from different scenarios/angles and experiencing the same scene in different scenarios, the analytic server may provide a new way of engaging with virtual reality (VR), augmented reality (AR), and smart/intelligent televisions. The users may be able to change the course of the scenarios or movies they are watching and determine how a story (movie, television) or scenario unfolds through the systems and methods described herein. This new wave of immersive technology may make the VR, AR and smart TV experience more realistic and captivating than conventional computer generated images.

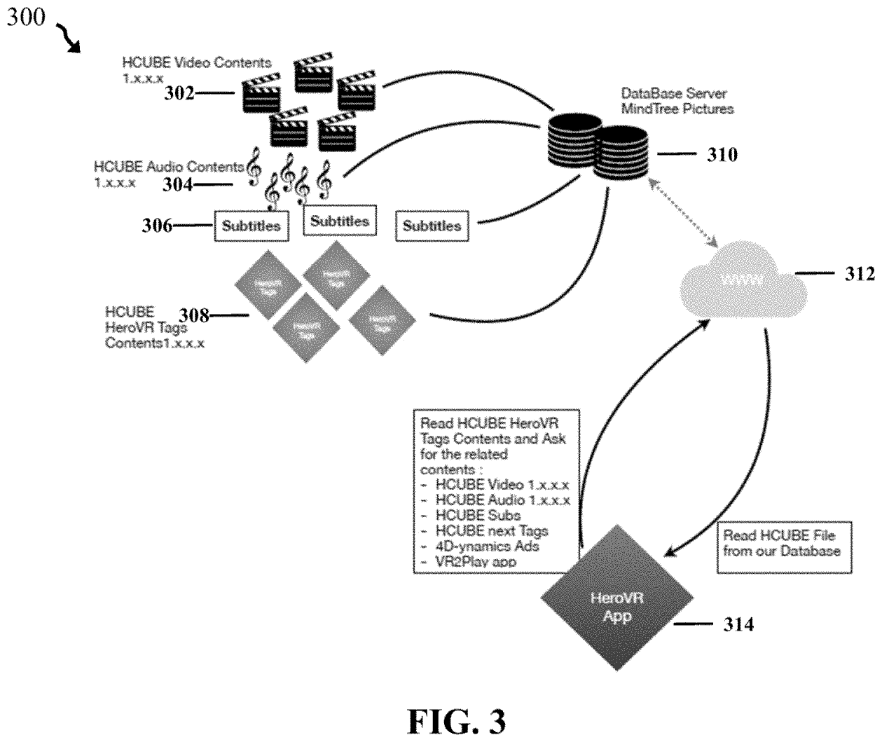

FIG. 3 illustrates an example 300 of generating and displaying electronic video files for different scenarios, according to an embodiment. The analytic server 310 may receive electronic video files for different scenarios. For example, for each scenario, the analytic server 310 may receive an image sequence file for video content 302, a soundtrack file for audio content 304, a subtitle file 306 for subtitle content. The analytic server 310 may create and embed tags 308 for the different scenarios in the movie. The tags 308 may include information on when, where, and how to choose a scenario during the video streaming. The analytic server 310 may comprise a database or in communication with a database. The analytic server 310 may store the received files 302-306 and the tags 308 in the database.

After a user initiates the video stream application 314 on the user's electronic device, the video stream application 314 may read the electronic video files provided by the analytic server 310 over the network 312. For example, the video stream application 314 may display a movie. The movie may comprise multiple scenarios at different time points. At a particular time point, the video stream application 314 may detect a tag indicating there are multiple scenarios/storylines for the story development. The video stream application 314 may display an interactive component, such as a menu, to allow the user to select a scenario. Based on the user's selection, the analytic server 310 may receive the user's request to view the movie in a particular scenario. The request for a particular scenario may correspond to the IDs of the image sequence file (video content), the soundtrack file (audio content), and the subtitle file (subtitle content) for that scenario. In addition, the specific scenario may also include other tags next tags) for further choices of storylines. The analytic server may retrieve the requested electronic files of the particular scenario based on the file IDs and send the electronic files to the user's electronic device over the network 312. The video stream application 314 may display such electronic files.

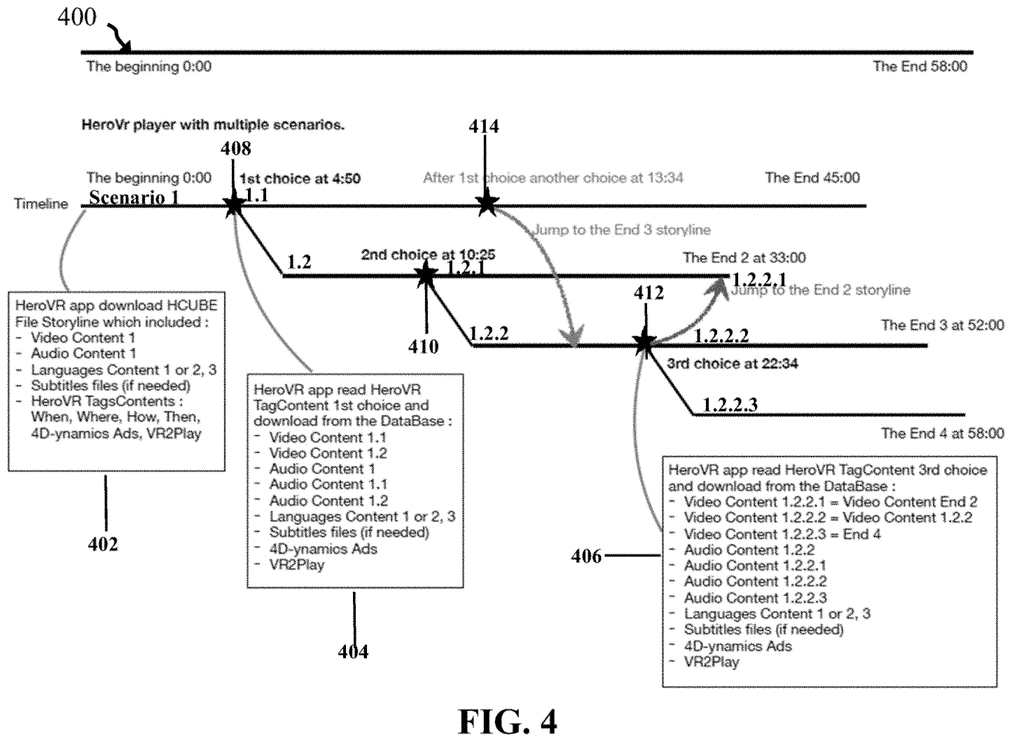

FIG. 4 illustrates an example 400 of a video with multiple scenarios at different time points, according to an embodiment. As shown in the figure, a movie may start at 0:00. As the movie starts, there may be only one scenario: scenario 1. As the movie keeps playing, at a first time point 4:50 408, there may be two scenarios: scenario 1.1 and scenario 1.2. In the storyline of scenario 1.1, the movie may end at 45:00. In the storyline of scenario 1.2, the movie may reach a second time point at 10:25 410, where there are another two scenarios: scenario 1.2.1 and scenario 1.2.2. In the storyline of scenario 1.2.1, the movie may end at 33:00. In the storyline of scenario 1.2.2, the movie may reach a third time point at 22:34 412, where there are another three scenarios: scenario 1.2.2.1, scenario 1.2.2.2, and scenario 1.2.2.3. In the storyline of scenario 1.2.2.1, the movie may jump to the end of the storyline of scenario 1.2.1. In storyline of scenario 1.2.2.2, the movie may end at 52:00. In the storyline of scenario 1.2.2.3, the movie may end at 58:00. Further, at a certain time point 414 of the storyline of scenario 1.1, the movie may have two scenarios. In the first scenario, the movie may end at 45:00. In the second scenario, the movie may jump to the end of the storyline of scenario 1.2.2.2.

In the process of displaying the movie, the video stream application may download different electronic video files for the different scenarios. As the movie starts at 0:00, there is only one scenario: scenario 1. The video stream application may receive and/or download the electronic video file for the display of scenario 1. The electronic video file 402 for scenario 1 may include video content 1, audio content 1 which may have different language versions (e.g., language contents), subtitle contents. In addition, the downloaded file may include a tag indicating when, where, and how the movie will provide different scenarios.

The movie may continue playing and reach a time point at 4:50 408. At this time point, the movie may include a tag indicating there are two scenarios/storylines, scenario 1.1 and scenario 1.2. To allow the user to view the two scenarios, the video stream application may download the electronic video files 404 for the two scenarios, including the video content 1.1 and audio content 1.1 for scenario 1.1 and the video content 1.2 and audio content 1.2 for scenario 1.2. Furthermore, the downloaded files may also include the different languages content and the subtitle files. In some embodiments, the previous audio content, such as audio content 1, before the particular time point 4:50 may continue presenting. For example, the user's VR equipment, such as a haptic suit, may feel the user's heartbeat in real time and send the heartbeat data to the user's VR electronic device displaying the movie (e.g., the head-mounted display or smart glasses) via Bluetooth. The analytic server may use such data in the tags to change scenarios. The analytic server may also use the heartbeat data as the audio content in different scenarios, including the previous scenario and the new scenarios.

Similarly, as the movie continues playing in the storyline of the scenario 1.2.2, the movie may reach the time point 22:34 412 and provide three scenarios: scenario 1.2.2.1, scenario 1.2.2.2, and scenario 1.2.2.3. To allow the user to view the three scenarios, the video stream application may download the electronic video files 406 for the three scenarios, including the video contents and audio contents for each scenario, the language contents, and subtitle files (if needed). The audio content from the previous scenario (scenario 1.2.2) may continue presenting.

In some embodiments, in addition to the video contents, audio contents, language contents, and subtitle files, the video stream application may also download other files, such as 4D dynamic advertisement and VR play contents customized for the movie.

### EXAMPLE

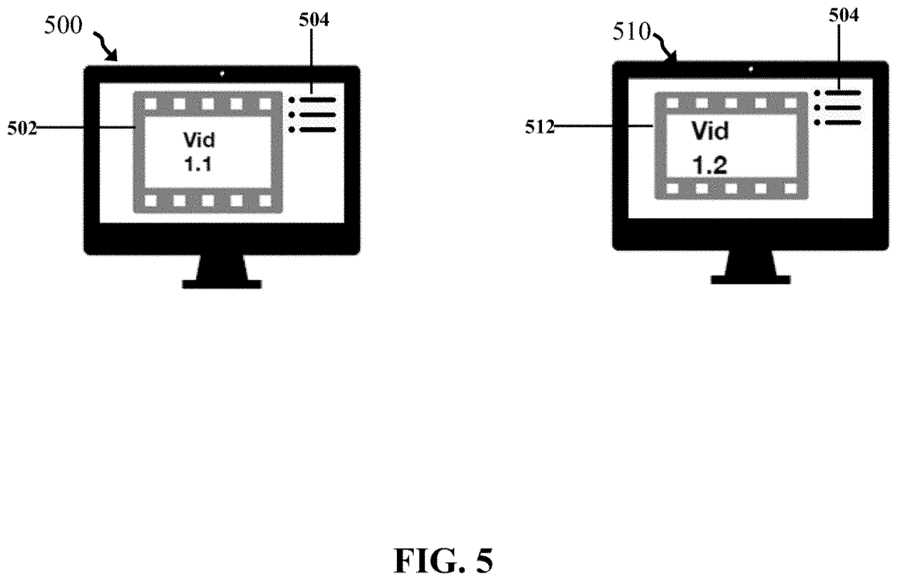

In a non-limiting example, a user may initiate a video stream software application on the user's electronic device. The software application may show a list of movies available for viewing. The user may select a movie with an indicator indicating that the movie includes multiple scenarios/storylines at different time points. The movie may have a tag for each such time point. As the electronic device plays the movie, the analytic server may detect a tag. The analytic server may display a menu on the right top of the device screen that includes different scenario options for the plot development. FIG. 5 illustrates an example of the graphical user interfaces when a user changes scenarios, according to an embodiment. As shown in the figure, the GUI 500 may initially display the electronic video file of a default scenario, such as a first electronic video file (e.g., Vid1.1) 502. GUI 500 may be displayed on any electronic device, such as a mobile device, television, or an augmented reality virtual reality display device. In the meantime, the analytic server may display the menu 504 in the GUI 500 that includes the different scenario options. The user may select a new scenario by interacting with the menu 504. The software application may display a second electronic video file (e.g., Vid1.2) 512 corresponding to the selected scenario in GUI 510. As the movie continues playing, the analytic server may detect another tag and display the menu 504 on the right top of the device screen again. The user may select another different scenario. The analytic server may repeat this process until the end of the video.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method comprising:
receiving, by a server, a plurality of electronic video files, each electronic video file corresponding to a different event sequence;
while displaying a first electronic video file on an electronic device, displaying, by the server, on a predetermined display portion of a display of the electronic device, an interactive graphical component comprising options for displaying a plurality of event sequences of the plurality of electronic video files;
activating, by the server, a sensor to monitor a user's actions while viewing the first electronic video file; and
in response to the user's action corresponding to a selection of a new event sequence, transitioning, by the server, from the first electronic video file to a second electronic video file corresponding to the new event sequence by displaying the second electronic video file instead of the first electronic video file.

2. The method of claim 1, wherein the first electronic video file corresponds to a default event sequence.

3. The method of claim 1, further comprising:
embedding, by the server, a tag into a video indicating the plurality of event sequences available at a time point;
detecting, by the server, the tag embedded in the video while playing the video; and
displaying, by the server, the interactive graphical component.

4. The method of claim 1, further comprising:
detecting, by the server, a tag embedded in a video indicating the plurality of event sequences available at a time point; and
pausing, by the server, the video and displaying the interactive graphical component.

5. The method of claim 1, further comprising displaying, by the server, the interactive graphical component for a limited amount of time.

6. The method of claim 1, further comprising displaying, by the server, the second electronic video file from beginning of the second electronic video file.

7. The method of claim 1, further comprising, at a time point of displaying the second electronic video file, displaying, by the server, the interactive graphical component comprising options for displaying a second plurality of event sequences.

8. The method of claim 1, wherein the first and second electronic video files are in multiple languages.

9. The method of claim 1, wherein each electronic video file comprises an image sequence, a soundtrack, and a subtitle.

10. The method of claim 1, further comprising receiving, by the server, the user's selection of the new event sequence through body movement, remote control, touch screen, voice control, emotion control and haptic control.

11. A computer system comprising (a) a plurality of electronic file generators, (b) an electronic device, and (c) a server in communication with the plurality of electronic file generators and the electronic device, the server being configured to:
receive a plurality of electronic video files from the plurality of electronic file generators, each electronic video file corresponding to a different event sequence;
while displaying a first electronic video file on the electronic device, display, on a predetermined display portion of a display of the electronic device, an interactive graphical component comprising options for displaying a plurality of event sequences of the plurality of electronic video files;
activate a sensor to monitor a user's actions while viewing the first electronic video file; and
in response to the user's action corresponding to a selection of a new event sequence, transition from the first electronic video file to a second electronic video file corresponding to the new event sequence by displaying the second electronic video file instead of the first electronic video file.

12. The computer system of claim 11, wherein the first electronic video file corresponds to a default event sequence.

13. The computer system of claim 11, wherein the server is further configured to:
embed a tag into a video indicating the plurality of event sequences available at a time point;
detect the tag embedded in the video while playing the video; and
display the interactive graphical component.

14. The computer system of claim 11, wherein the server is further configured to:
detect a tag embedded in a video indicating the plurality of event sequences available at a time point; and
pause the video and display the interactive graphical component.

15. The computer system of claim 11, wherein the server is further configured to display the interactive graphical component for a limited amount of time.

16. The computer system of claim 11, wherein the server is further configured to display the second electronic video file from beginning of the second electronic video file.

17. The computer system of claim 11, wherein the server is further configured to, at a time point of displaying the second electronic video file, display the interactive graphical component comprising options for displaying a second plurality of event sequences.

18. The computer system of claim 11, wherein the first and second electronic video files are in multiple languages.

19. The computer system of claim 11, wherein each electronic video file comprises an image sequence, a soundtrack, and a subtitle.

20. The computer system of claim 11, wherein the server is further configured to receive the user's selection of the new event sequence through body movement, remote control, touch screen, voice control, emotion control and haptic control.
